(19) United States
(12) Patent Application Publication
(10) Pub. No.: US 2011/0246799 A1
(43) Pub. Date: Oct. 6, 2011

(54) DATA-COLLECTION APPARATUS AND DATA-COLLECTION SYSTEM USING THE SAME

(76) Inventors: Tomohiko Tanimoto, Tokyo (JP); Takahiro Shirota, Tokyo (JP); Katsuhiro Sumi, Tokyo (JP); Hiroyuki Kobayashi, Chiba-ken (JP); Kimito Idemori, Saitama-ken (JP); Nobutaka Nishimura, Tokyo (JP)

(21) Appl. No.: 13/022,321

(22) Filed: Feb. 7, 2011

(30) Foreign Application Priority Data
Mar. 30, 2010 (JP) P2010-079847

(51) Int. Cl. G06F 1/32

(52) U.S. Cl. 713/310

(57) ABSTRACT

Embodiments relate to a data-collection apparatus and a data-collection system using the same. The data-collection apparatus includes a battery, a wireless unit to communicate wirelessly to an external device, a measurement unit to measure a measurement target, a power-supply circuit unit to control power supply to the wireless unit and the measurement unit, and a controller. In response to a data-collection start command from the external device, the controller performs a control such that the power-supply circuit unit supplies power to the measurement unit and wireless unit, and that the data measured by the measurement unit is transmitted via the wireless unit to the external device. In response to a power-saving command from the external device, the controller performs a control such that the power-supply circuit unit stops supplying power to the measurement unit and wireless unit for a predetermined period.

### CROSS-REFERENCE TO RELATED APPLICATION(S)

This application is based upon and claims the benefit of priority from the prior Japanese Patent Application No. 2010-079847, filed on Mar. 30, 2010, the entire contents of which are incorporated herein by reference.

### FIELD

Following embodiments relate to a data-collection apparatus to collect data on vibrations and sounds generated while a plant apparatus is operating and to a data-collection system using the data-collection apparatus.

### BACKGROUND

Rotary portions and movable portions of a plant apparatus wear or deform if used for a prolonged time. The wear and deformation of rotary portions and movable portions are known to alter sounds and vibrations generated by the plant apparatus in operation.

A data-collection system has been developed which collects periodically data on the sounds and vibrations of rotary portions and movable portions in a plant apparatus, and prompts the operator to do maintenance work for the rotary portions and movable portions before these portions fall into abnormal states (see, for example, JP, P2009-12891A).

The data-collection apparatus used in a plant apparatus is frequently installed in a place where supplying electric power through a cable is difficult. The data-collection apparatus installed in a place where it is difficult to install cables uses as a power supply a battery which can supply electric power only for a limited period.

Conventional data-collection systems, however, have no appropriate measures to save energy, and thus have a problem of a short battery-replacement cycle.

### BRIEF DESCRIPTION OF THE DRAWINGS

FIG. 1 is a diagram illustrating the configuration of a data-collection system according to a first embodiment;

FIG. 2 is a diagram illustrating the internal configuration of a relay apparatus according to the first embodiment of the invention;

FIG. 3 is a diagram illustrating the internal configuration of a data-collection apparatus according to the first embodiment;

FIG. 4 is a sequence diagram illustrating the operations of the first embodiment; and

FIG. 5 is a sequence diagram illustrating the operations of a second embodiment.

### DETAILED DESCRIPTION

A data-collection system according to one embodiment includes a plurality of data-collection apparatuses; a relay apparatus to communicate wirelessly to the plurality of data-collection apparatuses; and a central administration apparatus to perform network communications to the relay apparatus. Each of the data-collection apparatuses includes: a battery to generate electric power; a wireless unit to communicate wirelessly to the relay apparatus; a measurement unit to measure a measurement target; a power-supply circuit unit to control supplying electric power from the battery to the wireless unit, a first controller, and the measurement unit; and the first controller to transmit data measured by the measurement unit to the relay apparatus via the wireless unit in response to a data-collection start command received from the relay apparatus, and to perform a control such that the power-supply circuit unit stops supplying electric power to the measurement unit, the first controller, and the wireless unit for a predetermined period in response to a power-saving command received from the relay apparatus. The relay apparatus includes: a storage unit to store the data received from the data-collection apparatuses; and a second controller, after storing the data in the storage unit, to transmit a collection-completion notification to the central administration apparatus and transmit the power-saving command to each of the data-collection apparatuses at predetermined time intervals, and when a transfer-start command is received from the central administration apparatus, to transmit the data stored in the storage unit to the central administration apparatus. The central administration apparatus includes a third controller to transmit the transfer-start command to the relay apparatus when the collection-completion notification is received from the relay apparatus, and to receive the data transmitted from the relay apparatus in response to the transfer-start command.

### First Embodiment

A first embodiment is described by referring to the drawings.

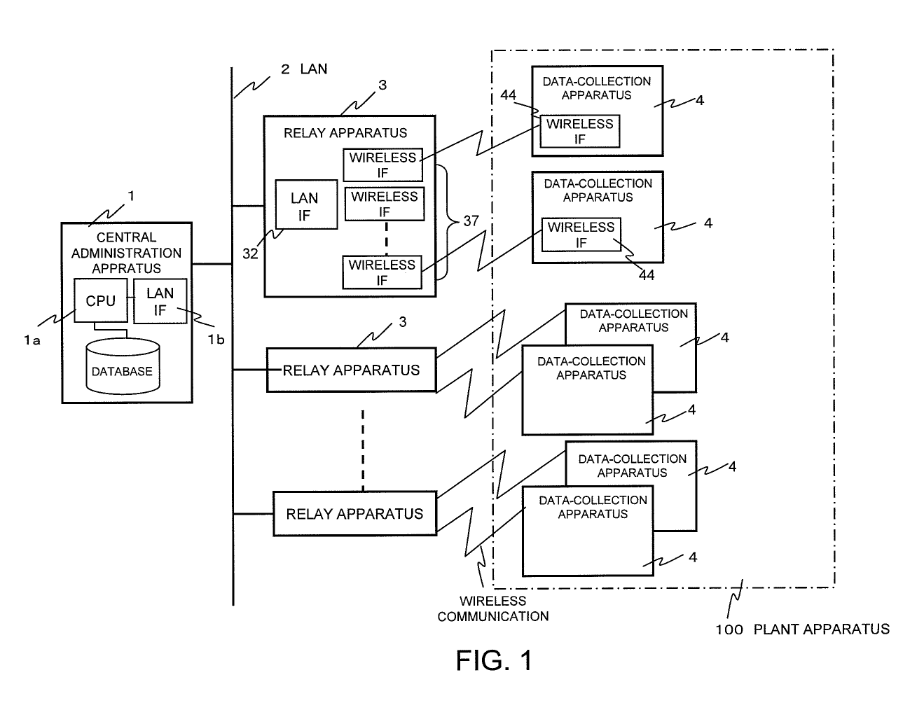

FIG. 1 illustrates the configuration of a data-collection system according to the first embodiment.

The data-collection system includes a central administration apparatus 1, a LAN 2, plural relay apparatuses 3, and plural data-collection apparatuses 4. The data-collection apparatuses 4 are installed in a plant apparatus 100.

The central administration apparatus 1 includes a central processing unit (CPU) 1a, a LAN interface 1b, a database 1c, a display unit which is not illustrated, and the like. The central administration apparatus 1 may include an external interface through which an operator inputs a command to start data collection when he/she wants to collect data.

The CPU 1a is a control device to control the entire central administration apparatus 1, and transmits the commands associated with data-collection requests via the LAN 2 to the plural relay apparatuses 3. The CPU 1a has a function of checking abnormalities by comparing the data sent from each data-collection apparatus 4 with the corresponding data stored in the database 1c.

The LAN interface 1b is an interface to connect the central administration apparatus 1 to the LAN 2. The database 1c stores the data on both the operating sounds and the vibrations generated by the plant apparatus 100 sent from the plural relay apparatuses 3. The database 1c also stores the data on both the operating sounds and the vibrations generated by the plant apparatus 100 while operating normally. Various data-storage media such as magnetic discs and semiconductor memories can be used as the data-storage medium for the database 1c. The display unit performs display based on the data on the operating sounds and the vibrations sent from the data-collection apparatuses 4.

The LAN 2 is a connection cable for a so-called local area network. Communications by means of electronic data are done through the LAN 2. The LAN 2 of the first embodiment is a wired LAN, but may employ a wireless LAN in place of the wired one.

The relay apparatus 3 controls the data-collection apparatuses 4 and administer the data collection. Each relay apparatus 3 is in charge of either a single or plural data-collection apparatuses 4, and receives, via wireless communications, measured data on the operating sounds and the vibrations of the plant apparatus 100 transmitted by the corresponding data-collection apparatus or apparatuses 4 installed in the plant apparatus 100. To this end, each relay apparatus 3 includes either a single or plural wireless interfaces 37. If a relay apparatus 3 includes plural wireless interfaces 37, the relay apparatus 3 is capable of collecting data on the operating sounds or the like of the plant apparatus 100 simultaneously from plural data-collecting apparatus 4. In addition, each relay apparatus 3 includes a LAN interface 32 to connect the relay apparatus 3 to the LAN 2. In response to a command sent from the central administration apparatus 1, each relay apparatus 3 transmits a command to the data-collection apparatus or apparatuses 4 that the relay apparatus 3 is in charge of. In addition, each relay apparatus 3 temporarily stores data sent from the corresponding data-correction apparatus or apparatuses 4, and transmits the data via the LAN 2 to the central administration apparatus 1.

Each data-collection apparatus 4 measures the operating sounds and the vibrations of the plant apparatus 100, and also measures the tilt angle of a measurement-target portion. Then, the data-collection apparatus 4 sends the measured data to the corresponding relay apparatus 3. The plural data-collection apparatuses 4 are installed in movable portions and fixed portions in the plant apparatus 100. The data-collection apparatuses 4 can simultaneously measure the operating sounds, the vibrations, and the like at their respective installation positions. Each data-collection apparatus 4 includes a wireless interface 44, which can communicate wirelessly to the wireless interface 37 of the relay apparatus 3 corresponding to the wireless interface 44. In this way, the data-collection apparatuses 4 can send the measured data to the corresponding relay apparatuses 3 via their respective wireless interfaces 44.

The plant apparatus 100 generates operating sounds, vibrations, and the like, and is the target machine for data collection. The description of the first embodiment is based on an example where the plant apparatus 100 is an escalator. Steps of the escalator are some examples of the movable portions. FIG. 1 shows that plural data-collection apparatuses 4 exist in the plant apparatus 100 and that plural relay apparatuses 3 exist outside of the plant apparatus 100. The relay apparatuses 3, however, may be installed in the plant apparatus 100.

Next, the operations of the central administration apparatus 1 are described.

The central administration apparatus 1 transmits, via the LAN interface 1b and then the LAN 2 to the plural relay apparatuses 3, commands associated with data-collection requests such as commands for starting data collection and commands for starting data transfer. The central administration apparatus 1 transmits such commands either periodically or in response to data-collection operations by the operator.

The central administration apparatus 1 receives, via the LAN interface 1b, the data, sent from the plural relay apparatuses 3, on the operating sounds, the vibrations, and the like of various portions in the plant apparatus 100. Then the central administration apparatus 1 makes the display unit display the received data. In addition, the central administration apparatus 1 checks abnormalities by analyzing the received data on the operating sounds and the vibrations. The collected data, the results of the analysis and of the checking, and the like are stored in the database 1c serving as the secondary storage apparatus of the central administration apparatus 1.

Next, the relay apparatuses 3 are described.

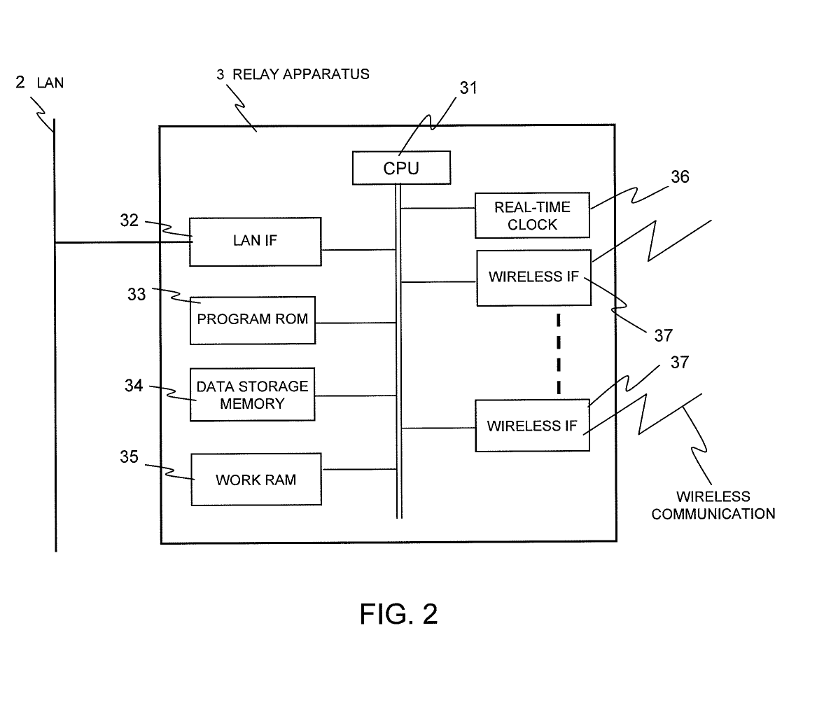

FIG. 2 is a block diagram illustrating the configuration of each relay apparatus 3. The relay apparatus 3 includes a CPU 31, the LAN interface 32, a program read only memory (ROM) 33, a data storage memory 34, a work random access memory (RAM) 35, a real-time clock 36, the plural wireless interfaces 37, and the like.

The CPU 31 is a control device that operates in accordance with a program stored in the program ROM 33. The CPU 31 controls each of the components of the relay apparatus 3. The program ROM 33 stores a program to make the CPU 31 operate in accordance with the commands sent from the central administration apparatus 1. The data storage memory 34 stores the data on the operating sounds and the vibrations received from the data-collection apparatus or apparatuses 4 that the relay apparatus 3 is in charge of.

The work RAM 35 is a working memory region where the data received from each data-collection apparatus 4 are temporarily stored. The real-time clock 36 is a timer module to set the value of time data in response to a command from the central administration apparatus 1. The real-time clock 36 counts time, and is also used for synchronizing the components with one another by means of the counted time. Each wireless interface 37 wirelessly communicates to the wireless interface 44 of the data-collection apparatus 4 corresponding to the wireless interface 37.

Next, the operations of each relay apparatus 3 are described.

The CPU 31 operates in accordance with the commands received from the LAN interface 32 but originally from the central administration apparatus 1. For example, upon receiving a data-collection start command, the CPU 31 transmits, via the plural wireless interfaces 37, a data-collection start command to the data-collection apparatus or apparatuses 4 that the relay apparatus 3 is in charge of. In addition, the CPU 31 receives, via the wireless interfaces 37, the data sent from the data-collection apparatuses 4, and stores temporarily the received data in the work RAM 35. On the basis of the data on the tilt angle of a measurement-target portion, whether a certain step of the escalator is turned over or not is determined. The received data is subdivided into pieces of data each of which corresponds to a period for a full round trip of each step, and the subdivided pieces of data are stored in the data storage memory 34. After receiving data, the CPU 31 transmits a data-collection completion notification via the LAN interface 32 to the central administration apparatus 1.

In addition, after the transmission of the data-collection completion notification to the central administration apparatus 1, the CPU 31 transmits power-saving commands to each data-collection apparatus 4 once every certain period via the corresponding wireless interface 37. The power-saving command is a command for turning the data-collection apparatuses 4 into a power-saving mode. The above-mentioned certain period is administered by the real-time clock 36.

After that, the CPU 31 receives, via the LAN interface 32, a data-transfer start command sent from the central administration apparatus 1. Then, the CPU 31 reads, from the data storage memory 34, the necessary collected data on the operating sounds and the vibrations, and sends the collected data to the central administration apparatus 1 via the LAN interface 32.

Next, the data-collection apparatuses 4 are described.

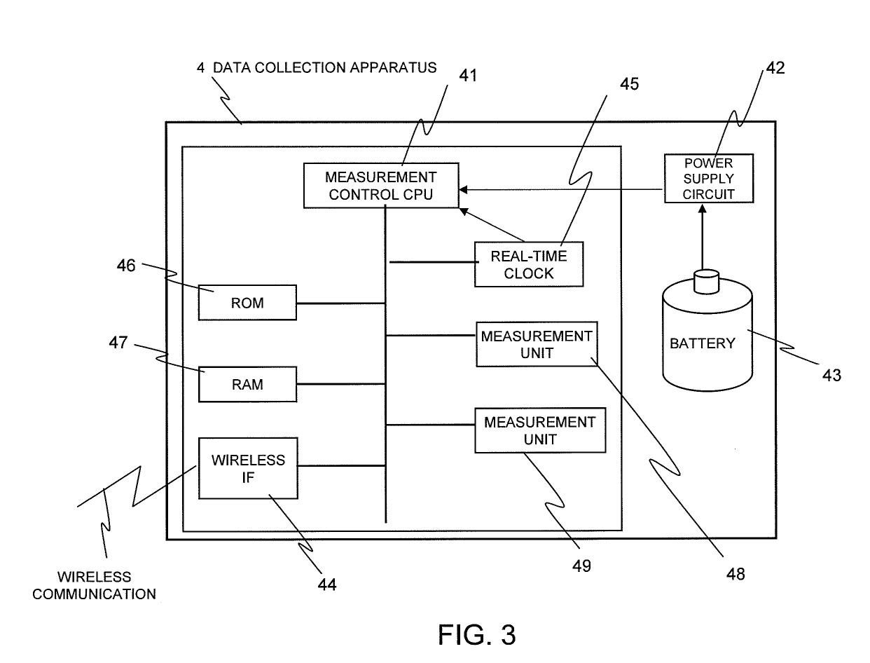

FIG. 3 is a block diagram illustrating the internal configuration of each data-collection apparatus 4. Each data-collection apparatus 4 includes a measurement-control CPU 41, a power-supply circuit 42, a battery 43, the wireless interface 44, a real-time clock 45, a ROM 46, a RAM 47, a measurement unit 48, another measurement unit 49, and the like.

The measurement-control CPU 41 is a control apparatus that operates in accordance with a control program stored in the ROM 46. The measurement-control CPU 41 operates upon receiving, via the wireless interface 44, various commands sent from the relay apparatus 3, such as the data-collection start command and the power-saving command.

The power-supply circuit 42 controls the supply of the electric power from the battery 43 to the components of the data-collection apparatus 4.

The battery 43 is an electric-power generating source, and is a power-supply source to supply electric power of a limited amount. That is, the battery 43 loses its ability to supply electric power after supplying electric power to the components of the data-collection apparatus 4 for a predetermined period. In the plant apparatus 100, some data-collection apparatuses 4 are installed in movable portions where it is difficult to supply electric power by means of a cable. For example, the data-collection apparatus 4 is installed in the step of escalator. For this reason, the data-collection apparatuses 4 are preferably driven by the battery 43. In addition, the data-collection apparatuses 4 installed in fixed portions may employ the battery 43.

The wireless interface 44 is a wireless device to transmit wirelessly, to the wireless interface 37 of the relay apparatus 3 corresponding to the wireless interface 44, the collected data on the operating sounds, the vibrations and the tilt angles of the plant apparatus 100. Since some of the data-collection apparatuses 4 are installed in movable portions in the plant apparatus 100, it is preferable to transmit the collected data wirelessly. For this reason, the data-collection apparatuses 4 use wireless communications.

The real-time clock 45 is a timer module to set the booting time of the measurement-control CPU 41 and the like times. The use of the real-time clock 45 allows the data-collection apparatus 4 to count time correctly and to start data collection accurately.

The ROM 46 stores the control program to be executed by the measurement-control CPU 41. The RAM 47 is a memory device used as a temporary storage region to store temporarily the control program having been loaded from the ROM 46.

The measurement unit 48 is a sound-collecting device to collect the operating sounds of the plant apparatus 100, and includes a microphone. The measurement unit 48 is connected to an interface to output the data on the collected operating sounds. The measurement unit 48 is installed in a movable portion or in a fixed portion in the plant apparatus 100. Alternatively, the measurement unit 48 may be a sensor to measure the vibrations. Still alternatively, the measurement unit 48 may include both a microphone and a sensor to measure the vibrations.

The measurement unit 49 is a tilt sensor to detect the tilt angle of the movable portion where the measurement unit 48 is installed. In the first embodiment, the measurement unit 49 detects the tilt angle of the step of the escalator. The relay apparatus 3 uses the data on the tilt angle to detect the turning-over of the step, and generates data delimiters. The data delimiters are used to subdivide the data on the operating sounds and the vibrations into pieces of data each corresponding to a period for a full round trip of each step.

Next, exemplar operations of the data-collection apparatus 4 are described.

The data-collection apparatus 4 collects measured data in response to the command received from the corresponding relay apparatus 3, and sends the measurement results to the corresponding relay apparatus 3. The measurement-control CPU 41 operates in accordance with the control program stored in the ROM 46. The measurement-control CPU 41 operates in response to the commands received via the wireless interface 44 from the relay apparatus 3 that corresponds to the data-collection apparatus 4.

In the first embodiment, the data-collection apparatus 4 operates either in the ordinary power-consumption mode or in the power-saving mode. In the ordinary power-consumption mode, the power-supply circuits 42 supplies electric power to the measurement-control CPU 41, the wireless interface 44, and the measurement units 48 and 49. In the power-saving mode, the power-supply circuit 42 supplies electric power to none of the measurement-control CPU 41, the wireless interface 44, and the measurement units 48 and 49.

When the measurement-control CPU 41 of the data-collection apparatus 4 that is in the ordinary power-consumption mode receives the data-collection start command from the relay apparatus 3, the measurement-control CPU 41 collects the data on the operating sounds, the vibrations and the tilt angles measured by the measurement units 48 and 49, and then stores temporarily the collected data in the RAM 47. Then, the measurement-control CPU 41 transmits, via the wireless interface 44 to the corresponding relay apparatus 3, the data on the operating sounds, the vibrations and the tilt angles stored in the RAM 47.

Upon receiving, from the relay apparatus 3, the power-saving command to limit the use of electric power, the measurement-control CPU 41 transmits a power-saving command to the power-supply circuit 42.

Upon receiving the power-saving command, the power-supply circuit 42 stops supplying electric power to the measurement-control CPU 41, the wireless interface 44, the measurement unit 48, the measurement unit 49, and the like. Thus, the measurement-control CPU 41, the wireless interface 44, and the measurement units 48 and 49 stop their respective operations, and the data-collection apparatus 4 is turned to be in the power-saving mode. Note that the real-time clock 45 always receives electric power supplied from the battery 43 and keeps on operating even in the power-saving mode.

After a predetermined time passes after the transition of the data-collection apparatus 4 to the power-saving mode, the real-time clock 45 sends a returning command to the power-supply circuit 42. In response to the returning command, the power-supply circuit 42 resumes the supply of electric power to the measurement-control CPU 41, the wireless interface 44, and the measurement units 48 and 49. Thus, the data-collection apparatus 4 is turned back to the ordinary power-consumption mode, and the data-collection apparatus 4 is made enable to receive the commands from the corresponding relay apparatus 3. The measurement unit 48 and the measurement unit 49 start their respective measurement operations once electric power is supplied. In the meanwhile, the measurement-control CPU 41 receives no data-collection start command and therefore collects no data. After returning to the ordinary power-consumption mode, the data-collection apparatus 4 receives the power-saving command from the corresponding relay apparatus 3, and then is turned from the ordinary power-consumption mode to the power-saving mode. In addition, after a predetermined time passes after the transition to the power-saving mode, the real-time clock 45 transmits a returning command to the power-supply circuit 42. Thus, the data-collection apparatus 4 is returned from the power-saving mode back to the ordinary power-consumption mode. From then on, the data-collection apparatus 4 repeats the transition from the ordinary power-consumption mode to the power-saving mode in response to the power-saving command sent from the corresponding relay apparatus 3 and the return from the power-saving mode back to the ordinary power-consumption mode in response to the returning command sent from the real-time clock 45.

As has been described above, after transmitting the collected measured data to the corresponding relay apparatus 3, the data-collection apparatus 4 receives the power-saving commands once every predetermined period from the corresponding relay apparatus 3. The data-collection apparatus 4 receives periodically the power-saving commands, because the wireless interface 44 cannot keep its communication function if the wireless interface 44 performs no communication for a long time.

After that, while the data-collection apparatus 4 that has returned back from the power-saving mode is in the ordinary power-consumption mode, the data-collection apparatus 4 receives the next data-collection start command from the corresponding relay apparatus 3. Then, as has been described earlier, the measurement-control CPU 41 collects the data measured by the measurement units 48 and 49, stores temporarily the collected data in the RAM 47, and then transmits the temporarily stored data via the wireless interface 44 to the corresponding relay apparatus 3.

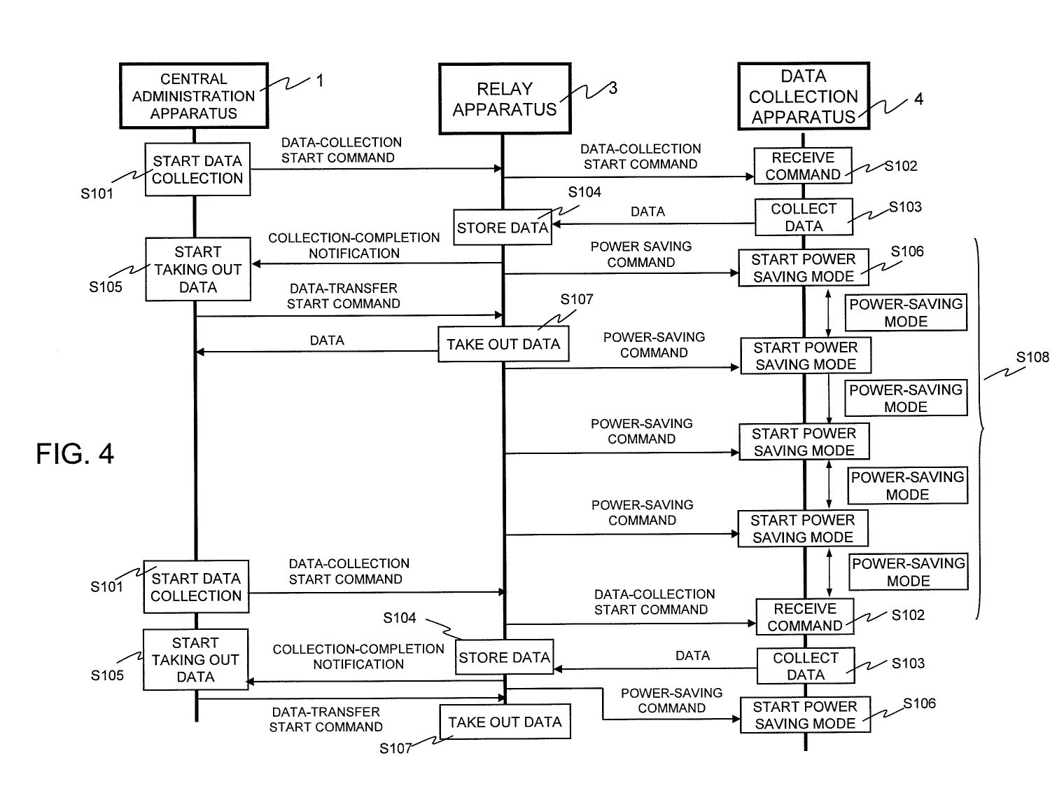

Next, the operations of the entire data-collection system of the first embodiment are described by referring to the sequence diagram of FIG. 4. The relay apparatus 3 and the data-collection apparatus 4 shown in FIG. 4 represent respectively one of the plural relay apparatuses 3 shown in FIG. 1 and one of the data-collection apparatuses 4 that the relay apparatus 3 is in charge of.

To start the data collection, the central administration apparatus 1 transmits a data-collection start command to the plural relay apparatuses 3 (step S101). In response to the data-collection start command received by the LAN interface 32, each relay apparatus 3 transmits, via the wireless interfaces 37, a data-collection start command simultaneously to all the data-collection apparatuses 4 that the relay apparatus 3 is in charge of.

The measurement-control CPU 41 of the data-collection apparatus 4 that is in the ordinary power-consumption mode receives, via the wireless interface 44, the data-collection start command sent from the corresponding relay apparatus 3 (step S102).

The measurement-control CPU 41 collects the data on the operating sounds, the vibrations and the tilt angles measured by the measurement units 48 and 49, and stores temporarily the collected data in the RAM 47 (step S103). After that, the measurement-control CPU 41 transmits, via the wireless interface 44 to the corresponding relay apparatus 3, the data on the operating sounds, the vibrations and the tilt angles stored in the RAM 47.

The CPU 31 of the relay apparatus 3 stores, in the data storage memory 34, the data on the operating sounds, the vibrations and the tilt angles received via the wireless interfaces 37. If the amount of the data is too large, the CPU 31 subdivides appropriately the data into pieces on the basis of the data on the tilt angles, and stores the resultant pieces of data in the data storage memory 34 (step S104). Then, the relay apparatus 3 transmits a collection-completion notification to the central administration apparatus 1. In addition, after the data collection, the CPU 31 of the relay apparatus 3 transmits, to the corresponding data-collection apparatuses 4, power-saving commands once every predetermined period.

Upon receiving the collection-completion notification from the relay apparatus 3 via the LAN interface 1b, the CPU 1a of the central administration apparatus 1 sends a data-transfer start command to the relay apparatus 3 (step S105).

In the meanwhile, upon receiving the power-saving command from the corresponding relay apparatus 3 via the wireless interface 44, the measurement-control CPU 41 of the data-collection device 4 transmits a power-saving command to the power-supply circuit 42. Upon receiving the power-saving command, the power-supply circuit 42 stops supplying electric power to the measurement-control CPU 41, the wireless interface 44, and the measurement units 48 and 49. Thus the data-collection apparatus 4 is turned into the power-saving mode (step S106). After a predetermined time passes after the transition of the data-collection apparatus 4 to the power-saving mode, the power-supply circuit 42 resumes the supplying of electric power to the measurement-control CPU 41, the wireless interface 44, and the measurement units 48 and 49 in response to a returning command sent from the real-time clock 45. Thus, the data-collection apparatus 4 is turned back to the ordinary power-consumption mode. Accordingly, the function of the wireless interface 44 is recovered, and thus the data-collection apparatus 4 is made enable to receive commands from the corresponding relay apparatus 3. From then on, the data-collection apparatus 4 repeats the reception of the power-saving command, the transition to the power-saving mode, and the return to the ordinary power-consumption mode in response to the returning command (step S108).

Upon receiving the data-transfer start command sent from the central administration apparatus 1, the CPU 31 in the relay apparatus 3 reads data from the data storage memory 34, and transmits the read data to the central administration apparatus 1 (step S107). Then, upon receiving the data on the operating sounds and the vibrations, the CPU 1a of the central administration apparatus 1 performs determination processing of abnormality checking and the like on the basis of the received data. In addition, the central administration apparatus 1 stores, in the database 1c, the received data and the determination results of the abnormality checking. Note that after the CPU 31 in the relay apparatus 3 reads the data from the data storage memory 34, the CPU 31 may delete the data from the data storage memory 34. After that, the central administration apparatus 1 sends another data-collection start command (step S101), the series of processing described above are executed repetitively.

Note that the description given above concerns the operations of only one of the data-collection apparatuses 4, but all the other data-collection apparatuses 4 operate similarly. Likewise the description given above concerns the operations of only one of the relay apparatuses 3, but all the other relay apparatuses 3 operate similarly.

As has been described thus far, the data-collection system of the first embodiment makes each data-collection apparatus 4 operate in the power-saving mode for a predetermined period. In the power-saving mode, power supply to the measurement-control CPU 41, the wireless interface 44, and the measurement units 48 and 49 are stopped to reduce the consumption of electric power. In addition, the data-collection apparatus 4 performs appropriately the administration of the timing for the transition to the power-saving mode. For this reason, according to the first embodiment, the battery-replacement cycle for the data-collection apparatus 4 can be prolonged. Specifically, each data-collection apparatus 4 operates in the power-saving mode to reduce the consumption of electric power except the period when the data-collection apparatus 4 measures data, collects the measured data, and sends the collected data to the corresponding relay apparatus 3, as well as the other necessary periods. In the data-collection system thus constructed, the power consumption of the data-collection apparatus 4 can be reduced.

In addition, in the data-collection system of the first embodiment, each data-collection apparatus 4 is turned back to the ordinary power-consumption mode once every predetermined period, and is made enable to receive the commands from the corresponding relay apparatus 3. For this reason, the data-collection apparatus 4 can receive a new command from the corresponding relay apparatus 3 when necessary. Accordingly, while achieving power saving, the data-collection system of the first embodiment collects data flexibly.

### Modification of First Embodiment

In the first embodiment, in most of the period when each data-collection apparatus 4 operates in the ordinary power-consumption mode, the data-collection apparatus 4 is actually in a stand-by mode waiting for a command to come from the corresponding relay apparatus 3. In the stand-by mode, operations of the measurement units 48 and 49 are not necessary. Accordingly, in this modification, while each data-collection apparatus 4 operates in the stand-by mode, electric power is supplied to the measurement-control CPU 41 and the wireless interface 44 but no electric power is supplied to the measurement units 48 and 49. In this way, each data-collection apparatus 4 of this modification can reduce the consumption of electric power in comparison to the first embodiment.

While each data-collection apparatus 4 operates in the stand-by mode, upon receiving a data-collection start command, the measurement-control CPU 41 sends, to the power-supply circuit 42, a command for supplying electric power to the measurement units 48 and 49. Upon receiving the command for supplying electric power to the measurement units 48 and 49, the power-supply circuit 42 supplies electric power to the measurement units 48 and 49, and thus the data-collection apparatus 4 is turned back to the ordinary power-consumption mode. In addition, the measurement-control CPU 41 collects data from the measurement units 48 and 49, and temporarily stores the collected data in the RAM 47. Then, the measurement-control CPU 41 reads the data from the RAM 47, and then transmits the read data to the corresponding relay apparatus 3. In this way, upon receiving the data-collection start command, each data-collection apparatus 4 can perform data collection and data transmission to the corresponding relay apparatus 3 as in the case of the first embodiment.

### Second Embodiment

Next, a second embodiment is described.

The second embodiment differs from the first embodiment in the following points. In the second embodiment, the CPU 31 in each relay apparatus 3 transmits no power-saving command to the corresponding data-collection apparatus 4, but transmits a collection-pattern command to the corresponding data-collection apparatus 4. In response to the collection-pattern command, the measurement-control CPU 41 in the data-collection apparatus 4 executes the necessary processing for turning the data-collection apparatus 4 from the power-saving mode back to the ordinary power-consumption mode, and performs the data collection. The collection-pattern command designates plural points of time together with the operations to be done at these points of time. The plural points of time include, for example, the time at which the data-collection apparatus 4 is turned from the power-saving mode back to the ordinary power-consumption mode and the time at which data collection is started.

The hardware configuration of the data-collection system of the second embodiment is identical to the corresponding configuration of the first embodiment. However, the programs to control the CPUs of the central administration apparatus 1, of the relay apparatuses 3, and of the data-collection apparatuses 4 are different from their respective counterparts in the first embodiment. For example, the ROM 46 of each data-collection apparatus 4 stores a program which turns the data-collection apparatus 4 from the power-saving mode back to the ordinary power-consumption mode at a predetermined time in accordance with the collection-pattern command. In addition, the stored program makes the measurement-control CPU 41 collect data in accordance with the collection-pattern command.

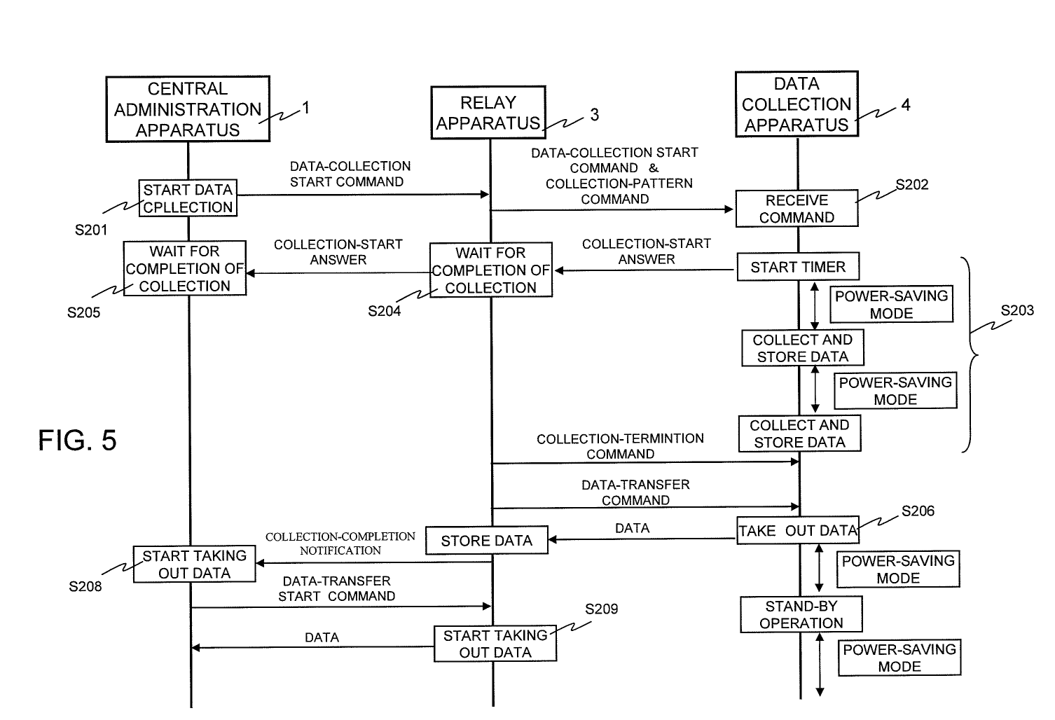

The operations of the entire data-collection system of the second embodiment are described by referring to the sequence diagram of FIG. 5. The relay apparatus 3 and the data-collection apparatus 4 shown in FIG. 5 represent respectively one of the plural relay apparatuses 3 shown in FIG. 1 and one of the data-collection apparatuses 4 that the relay apparatus 3 is in charge of.

The central administration apparatus 1 transmits a data-collection start command to the plural relay apparatuses 3 via the LAN 2 (step S201).

Upon receiving the data-collection start command, the CPU 31 of each relay apparatus 3 transmits, via wireless communications, a collection-pattern command and a data-collection start command simultaneously to all the data-collection apparatuses 4 that the relay apparatus 3 is in charge of. The measurement-control CPU 41 in each data-collection apparatus 4 receives, via the wireless interface 44, the collection-pattern command and the data-collection start command (step S202).

Upon receiving the collection-pattern command and the data-collection start command, the measurement-control CPU 41 in each data-collection apparatus 4 transmits a collection-start answer to the corresponding relay apparatus 3. In addition, the measurement-control CPU 41 notifies the real-time clock 45 of a command for starting the timer for a command for returning in accordance with the time designated by the collection-pattern command. In addition, the measurement-control CPU 41 transmits a power-saving command to the power-supply circuit 42. Upon receiving the power-saving command, the power-supply circuit 42 stops supplying electric power to the measurement-control CPU 41, the wireless interface 44, and the measurement units 48 and 49. Thus, the data-collection apparatus 4 is turned to be in the power-saving mode.

After the transition of the data-collection apparatus 4 to the power-saving mode and at a predetermined point of time set by the command for starting the timer, that is, after a predetermined time (e.g., 10 minutes) passes after the transition to the power-saving mode, the real-time clock 45 sends a returning command to the power-supply circuit 42. Upon receiving the returning command, the power-supply circuit 42 resumes the supplying of electric power to the measurement-control CPU 41, the wireless interface 44, and the measurement units 48 and 49. Thus, the data-collection apparatus 4 is turned back to the ordinary power-consumption mode. The measurement unit 48 measures the operating sounds and the vibrations in the plant apparatus 100 and the measurement unit 49 measures the tilt angles. In addition, the measurement-control CPU 41 sends a query about the time to the real-time clock 45, and refers to the collection pattern command to know if it is the time for the measurement-control CPU 41 to collect and store data. If it is, the measurement-control CPU 41 collects the data measured by the measurement units 48 and 49, and stores the collected data in the RAM 47.

From then on, in a similar manner described above, the measurement-control CPU 41 notifies the real-time clock 45 of a new command for starting a timer for a command for returning in accordance with the time designated by the collection-pattern command, and transmits a power-saving command to the power-supply circuit 42. Thus, the data-collection apparatus 4 is turned to be in the power-saving mode. Then, at a predetermined point of time when a predetermined period passes after the transition to the power-saving mode, the data-collection apparatus 4 is turned from the power-saving mode back to the ordinary power-consumption mode, and performs the collecting and the storing of data in accordance with the collection-pattern command. The data-collection apparatus 4 repeats the transition to the power-saving mode, the returning to the ordinary power-consumption mode, and the collecting and the storing of data in accordance with the collection-pattern command (step S203).

In the meanwhile, upon receiving the collection-start answer via the wireless interface 37 from each of the corresponding data-collection apparatuses 4, the CPU 31 of the relay apparatus 3 transmits the collection-start answer to the central administration apparatus 1 and waits for completion of data collection (step S204). Upon receiving the collection-start answer, the CPU 1a of the central administration apparatus 1 waits for the collected data to come from the relay apparatus 3 (step S205).

In addition, after transmitting the collection-start answer to the central administration apparatus 1, the CPU 31 of the relay apparatus 3 notifies the real-time clock 36 of a command for starting the timer of a predetermined time (e.g., 30 minutes). When the real-time clock 36 finishes counting the predetermined time, the CPU 31 of the relay apparatus 3 transmits a collection-termination command and a data-transfer command to the corresponding data-collection apparatus 4. The data-collection apparatus 4 at this moment operates in the ordinary power-consumption mode.

The administration of data-collection time by the real-time clock 36 in the relay apparatus 3 may be replaced by the issuing, by the central administration apparatus 1, of the collection-termination command to finish the operation of collecting data together with the relaying, by the relay apparatus 3, of the collection-termination command to the data-collection apparatus 4.

Upon receiving the data-collection-termination command and the data-transfer command, the measurement-control CPU 41 in the data-collection apparatus 4 reads, from the RAM 47, the measured data that have been stored temporarily in the RAM 47 since the reception of the data-collection start command till the reception of the data-collection-termination command. Then, the measurement-control CPU 41 transmits the read data to the relay apparatus 3 (step S206). If the measured data cannot be sent at a single event, the measured data is subdivided into plural pieces to be sent separately.

Upon receiving the data on the operating sounds, the vibrations and the tilt angles via the wireless interface 37, the CPU 31 of the relay apparatus 3 stores the received data in the data storage memory 34. After that, the CPU 31 of the relay apparatus 3 transmits a data-collection completion notification to the central administration apparatus 1.

Upon receiving the collection-completion notification from the relay apparatus 3, the CPU 1a of the central administration apparatus 1 transmits a data-transfer start command to the relay apparatus 3 (step S208).

Upon receiving the data-transfer start command sent from the central administration apparatus 1, the CPU 31 of the relay apparatus 3 reads data from the data storage memory 34, and transmits the read data to the central administration apparatus 1 (step S209). The central administration apparatus 1 uses the received data to analyze abnormal sounds. In addition, the central administration apparatus 1 performs, for example, the storing of the received data and the analyzed data, as well as the displaying of the received data and the analyzed data.

When the data-collection apparatus 4 finishes the transmission of the measured data to the relay apparatus 3, the data-collection apparatus 4 notifies the real-time clock 45 of a command for starting a new timer for the returning command in accordance with the time designated by the collection-pattern command. In addition, the measurement-control CPU 41 sends a power-saving command to the power-supply circuit 42. Thus, the data-collection apparatus 4 is turned to be in the power-saving mode that continues for a predetermined period.

At a designated point of time when a predetermined time passes after the transition of the data-collection apparatus 4 to the power-saving mode, the real-time clock 45 notifies the power-supply circuit 42 of a returning command, and thus the data-collection apparatus 4 is turned back to the ordinary power-consumption mode. The measurement-control CPU 41 sends a query for the time to the real-time clock 45, and refers to the collection-pattern command to know if the data-collection apparatus 4 should perform a stand-by operation for a predetermined period. Then, the data-collection apparatus 4 performs a stand-by operation for the predetermined period. During the stand-by operation, the data-collection apparatus 4 keeps on operating in the ordinary power-consumption mode without performing any operation of collecting or storing data, and waits for a new command to come from the relay apparatus 3.

If no new command comes from the relay apparatus 3, the measurement-control CPU 41 notifies the real-time clock 45 of a command for starting a new timer for the returning command in accordance with the time designated by the collection-pattern command. In addition, the measurement-control CPU 41 sends a power-saving command to the power-supply circuit 42, and thus the data-collection apparatus 4 is turned to be in the power-saving mode. From then on, the data-collection apparatus 4 repeats the returning from the power-saving mode to the ordinary power-consumption mode, the stand-by operation to wait for a new command to come from the relay apparatus 3, and the transition from the ordinary power-consumption mode to the power-saving mode. If the data-collection apparatus 4 that is in the ordinary power-consumption mode and in the stand-by operation receives, from the relay apparatus 3, a new data-collection start command and a new collection-pattern command, the operations of those steps described above are repeated in accordance with the newly-received collection-pattern command.

Note that the description given above concerns the operations of only one of the data-collection apparatuses 4, but all the other data-collection apparatuses 4 operate similarly. Likewise the description given above concerns the operations of only one of the relay apparatuses 3, but all the other relay apparatuses 3 operate similarly.

As has been described thus far, the data-collection system of the second embodiment makes each data-collection apparatus 4 operate in the power-saving mode for a predetermined period. In the power-saving mode, power supply to the measurement-control CPU 41, the wireless interface 44, and the measurement units 48 and 49 are stopped to reduce the consumption of electric power. For this reason, according to the second embodiment, the cycle of battery replacement for each data-collection apparatus 4 can be prolonged. Specifically, each data-collection apparatus 4 operates in the power-saving mode to reduce the consumption of electric power except the period when the data-collection apparatus 4 measures data, collects the measured data, and sends the collected data to the corresponding relay apparatus 3, as well as the other necessary periods. In the data-collection system thus constructed, the power consumption of the data-collection apparatus 4 can be reduced.

In addition, in the data-collection system of the second embodiment, each data-collection apparatus 4 that is in the stand-by operation is made enable to receive commands from the corresponding relay apparatus 3. For this reason, the data-collection apparatus 4 can receive a new command from the corresponding relay apparatus 3 when necessary. Accordingly, while achieving power saving, the data-collection system of the second embodiment collects data flexibly.

### Modification of Second Embodiment

Since the data-collection apparatus 4 that is in the stand-by operation of the above-described second embodiment performs no operation of collecting or storing data, the power-supply circuit 42 may supply no electric power to any of the measurement units 48 and 49 while the data-collection apparatus 4 is in the stand-by operation. If no electric power is supplied to the measurement units 48 and 49, the data-collection apparatus 4 can reduce furthermore the consumption of electric power, and can achieve longer battery-replacement cycle. Note that if the data-collection apparatus 4 that is in the stand-by operation receives a new command, the data-collection apparatus 4 supplies electric power to the measurement units 48 and 49 and is turned to be in the ordinary power-consumption mode in accordance with the command.

As has been described thus far, according to the data-collection system and the data-collection apparatus of the present invention, the electric power consumed by the data-collection apparatus can be reduced and a longer service life of the battery can be achieved. Consequently, a longer battery-replacement cycle can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data-collection apparatus comprising:
a battery to generate electric power;
a wireless unit to communicate wirelessly to an external device;
a measurement unit to measure a measurement target;
a power-supply circuit unit to control supplying electric power from the battery to the wireless unit, the measurement unit, and a controller; and
the controller to collect data measured by the measurement unit and transmit the data collected to the external device via the wireless unit in response to a data-collection start command received from the external device, and to perform a control such that the power-supply circuit unit stops supplying electric power to the measurement unit, the controller, and the wireless unit for a predetermined period in response to a power-saving command received from the external device.

2. The data-collection apparatus of claim 1, wherein after the predetermined period passes, the power-supply circuit unit supplies electric power to the controller and the wireless unit, and thereby the controller is enabled to receive a command from the external device.

3. The data-collection apparatus of claim 1, wherein
after the predetermined period passes, the power-supply circuit unit supplies electric power to the controller and the wireless unit, and
when a new power-saving command is received from the external device, the controller performs a control such that the power-supply circuit unit again stops supplying electric power to the controller and the wireless unit for a predetermined period.

4. The data-collection apparatus of claim 1, comprising a plurality of measurement units.

5. A data-collection system comprising:
a plurality of data-collection apparatuses;
a relay apparatus to communicate wirelessly to the plurality of data-collection apparatuses; and
a central administration apparatus to perform network communications to the relay apparatus,
wherein each of the data-collection apparatuses includes:
a) a battery to generate electric power;
b) a wireless unit to communicate wirelessly to the relay apparatus;
c) a measurement unit to measure a measurement target;
d) a power-supply circuit unit to control supply of electric power from the battery to the wireless unit, a first controller, and the measurement unit; and
e) the first controller to transmit data measured by the measurement unit to the relay apparatus via the wireless unit in response to a data-collection start command received from the relay apparatus, and to perform a control such that the power-supply circuit unit stops supplying electric power to the measurement unit, the first controller, and the wireless unit for a predetermined period in response to a power-saving command received from the relay apparatus,
the relay apparatus includes:
f) a storage unit to store the data received from the data-collection apparatuses; and
g) a second controller
after storing the data in the storage unit, to transmit a collection-completion notification to the central administration apparatus and transmit the power-saving command to each of the data-collection apparatuses at predetermined time intervals, and
when a transfer-start command is received from the central administration apparatus, to transmit the data stored in the storage unit to the central administration apparatus, and
the central administration apparatus includes:
h) a third controller to transmit the transfer-start command to the relay apparatus when the collection-completion notification is received from the relay apparatus, and to receive the data transmitted from the relay apparatus in response to the transfer-start command.

6. A data-collection apparatus comprising:
a battery to generate electric power;
a wireless unit to communicate wirelessly to an external device;
a measurement unit to measure a measurement target;
a power-supply circuit unit to control supply of electric power from the battery to the wireless unit and the measurement unit; and
a controller
when a data-collection start command is received via the wireless unit from the external device, to transmit a collection-start answer via the wireless unit to the external device, and to perform a control such that the power-supply circuit unit stops supplying electric power to the measurement unit, the controller, and the wireless unit for a first predetermined period until a collection-termination command for data collection termination is received from the external device,
after the first predetermined period passes, to perform a control such that the power-supply circuit unit supplies electric power to the measurement unit, the controller, and the wireless unit, and thereby collect the data measured by the measurement unit, and
when a data-transmission command is received from the external device, to transmit the collected data to the external device.

7. The data-collection apparatus of claim 6, wherein
after collecting the data measured by the measurement unit, the controller performs a control such that the power-supply circuit unit stops supplying electric power to the wireless unit for a second predetermined period, and
after the second predetermined period passes, the controller performs a control such that the power-supply circuit unit supplies electric power to the measurement unit, the controller, and the wireless unit and thereby collects the data measured by the measurement unit.

8. The data-collection apparatus of claim 6, wherein
after transmitting the collected data to the external device via the wireless unit, the controller performs a control such that the power-supply circuit unit again stops supplying electric power to the measurement unit, the controller, and the wireless unit for a second predetermined period, and
after the second predetermined period passes, the controller performs a control such that the power-supply circuit unit supplies electric power to the measurement unit, the controller, and the wireless unit to enable the wireless unit to receive a command from the external device.

9. The data-collection apparatus of claim 6, wherein
the controller receives a collection-pattern command from the external device, and
in accordance with the received collection-pattern command, the controller controls the power-supply circuit unit as to whether to stop supplying or to supply electric power to the measurement unit, the controller, and the wireless unit, and collects the data measured by the measurement unit.

10. The data-collection apparatus of claim 6, wherein the controller includes a central processing unit (CPU) and a timer.

11. A data-collection system comprising:
a plurality of data-collection apparatuses;
a relay apparatus to communicate wirelessly to the plurality of data-collection apparatuses; and
a central administration apparatus to perform network communications to the relay apparatus,
wherein each of the data-collection apparatuses includes:
a) a battery to generate electric power;
b) a wireless unit to communicate wirelessly to the relay apparatus;
c) a measurement unit to measure a measurement target;
d) a power-supply circuit unit to control supply of electric power from the battery to the wireless unit, and the measurement unit; and
e) a first controller
when a data-collection start command is received via the wireless unit from the external device, to transmit a collection-start response via the wireless unit to the external device, and to perform a control such that the power-supply circuit unit stops supplying electric power to the measurement unit, the first controller, and the wireless unit for a first predetermined period until the first controller receives a collection-termination command from the external device,
after the first predetermined period passes, to perform a control such that the power-supply circuit unit supplies electric power to the measurement unit, the first controller, and the wireless unit, and thereby to collect the data measured by the measurement unit, and
when a data-transmission command is received from the external device, to transmit the collected data to the external device,
the relay apparatus includes:
f) a storage unit to store the data received from the data-collection apparatuses; and
g) a second controller
to transmit the collection-termination command and a data-transmission command to each of the data-collection apparatuses after a second predetermined period passes after the data-collection start answer is received from the data-collection apparatus, and
to transmit a collection-completion notification to the central administration apparatus after storing in the storage unit the data received from the data-collection apparatus in response to the data-transmission command, and
the central administration apparatus includes:
h) a third controller to transmit the transfer-start command to the relay apparatus when the central administration apparatus receives the collection-completion notification from the relay apparatus, and to receive the data transmitted from the relay apparatus in response to the command.
